(19) United States
(12) Patent Application Publication
(10) Pub. No.: US 2022/0398930 A1
(43) Pub. Date: Dec. 15, 2022

(54) METHOD AND SYSTEM FOR VALIDATING AVIATION DATA

(71) Applicant: GE Aviation Systems LLC, Grand Rapids, MI (US)

(72) Inventors: Jeffrey M. Plantinga, Grand Rapids, MI (US); Ralph Demmon Boozer, Rockford, MI (US); Benjamin Ivan Coutts, Rockford, MI (US)

(21) Appl. No.: 17/344,300

(22) Filed: Jun. 10, 2021

(51) Int. Cl. G08G 5/00

(52) U.S. Cl. CPC G08G 5/0034; G08G 5/0013; G08G 5/0021; G08G 5/0086

(57) ABSTRACT

A method to validate a flight plan for an aircraft includes receiving aviation data, determining a flight plan based on the aviation data; determining a set of flight parameters for the flight plan, receiving terrain data, and performing a safety validation of the flight plan, wherein the safety validation comprises: comparing the set of flight parameters with the terrain data; and determining, based on the comparison, whether the flight plan satisfies predetermined flight criteria, and in the event of a determination that the flight plan does not satisfy the predetermined flight criteria, displaying a first notification indicative of the determination.

### TECHNICAL FIELD

This disclosure relates generally to automatically validating aviation data, and more specifically to validating certain aviation data with respect to a flight plan.

### BACKGROUND

A variety of aviation data is available for use on an aircraft. Data relevant to a flight for an aircraft can be available from a number of aviation data sources. For example, an aircraft's navigation system (e.g. Flight Management System (FMS)) typically stores several databases. Another typical database used for flight planning, navigation, trajectory prediction, and flight procedures is a Navigation Database (NDB), which can be stored in the FMS or in a remote server. The NDB is a static database that is updated routinely, for example, in accordance with a 28-day Aeronautical Information Regulation and Control (AIRAC) cycle. Currently, aircraft maintenance personnel are required by aviation authorities to manually update the NDB on this cycle.

Among other things, the NDB can be used to develop flight procedures. A flight procedure, such as an instrument flight procedure (IFP), is a set of predetermined flight maneuvers with specified protection from obstacles in order to meet predetermined flight conditions and achieve an orderly flow of air traffic. Flight procedures can be linked to an airport and can be specified as an arrival, departure, or approach procedure. Additionally, a set of flight plans for specific flight/s can be developed based on the flight procedures in the NDB. Flight plans typically include at least a planned route or flight path for a given flight of an aircraft.

### BRIEF DESCRIPTION

An aspect of the present disclosure relates to a method for validating aviation data. The method includes receiving a set of aviation data from a first database, determining a flight plan based on the aviation data, determining a set of flight parameters for the flight plan, receiving a set of terrain data from a second database, performing a validation of the flight plan, wherein the validation comprises comparing the set of flight parameters with the set of terrain data, and determining, based on the comparing, whether the flight plan satisfies a predetermined flight criteria; related to safe flight; and when the determining indicates that the flight plan does not satisfy the predetermined flight criteria, displaying a first notification.

In another aspect, the disclosure relates to a system for an aircraft. The system comprises a controller module adapted to validate a flight plan, and configured to receive a set of aviation data, determine a flight plan based on the aviation data; determine a set of flight parameters for the flight plan; receive a set of terrain data, and perform a safety validation of the flight plan, wherein the safety validation comprises comparing the set of flight parameters with the set of terrain data; determining, based on the comparing, whether the flight plan presents a risk to safe flight; and when the determining indicates the flight plan does not satisfy the predetermined flight criteria, displaying a first notification indicative of the determination on a display.

In some respects, validating aviation data in accordance with the systems and methods is useful to confirm compliance of individual flight plans, e.g. with safety guidance or regulations. In other respects, validating aviation data can be useful to assess health, integrity and performance of avionics systems for generating flight plans.

### BRIEF DESCRIPTION OF THE DRAWINGS

A full and enabling disclosure of the present description, including the best mode thereof, directed to one of ordinary skill in the art, is set forth in the specification, which refers to the appended FIGS., in which:

FIG. 1 is a schematic illustration of an aircraft and ground system according to aspects described herein.

FIG. 2 is a block diagram of a system that can be utilized with the aircraft and ground system of FIG. 1, according to aspects described herein.

FIG. 3 is a flow chart diagram illustrating a method of validating a flight plan according to aspects described herein.

### DETAILED DESCRIPTION

Conventional aircraft can include a Terrain Avoidance Warning System (TAWS) such as an Enhanced Ground Proximity Warning System (EGPWS) or a Ground Collision Avoidance System (GCAS). Such TAWS are used on aircraft to decrease undesired terrain incursions, such as a controlled flight into terrain. TAWS typically include a database having terrain and obstacle information and provide a warning to pilots, (e.g., based on radio altimeter and terrain closure rates), when an aircraft is in potentially hazardous proximity to terrain, including obstacles, such as man-made structures. For example, the EGPWS relates aircraft position, (e.g., from a GPS source, which can be on board, or provided by the aircraft FMS) to an on-board database having terrain and obstacle information. A set of cautions or warnings can be generated based on the radio altimeter and relative position of the aircraft during flight.

For purposes of illustration and discussion, the present disclosure will be described with respect to a navigational database for an aircraft. It will be understood that the disclosure can have applicability in other vehicles or systems, and can be used to provide benefits in industrial, commercial, and residential applications that use or require data including navigational data.

A static database used for flight planning and trajectory prediction such as an NDB, can be stored in the FMS of an aircraft or an external system or server, and updated, for example, by the aviation data provided in Aeronautical Radio Incorporated (ARINC) 424 standard files or a Digital Aeronautical Flight Information File (DAFIF). Among other things, the NDB can be used to develop flight procedures such as arrival, departure, or approach procedures for one or more airports, heliports, or aerodromes. A flight plan or set of flight plans can then be developed based at least in part on the flight procedures in the NDB. The flight plan or set of flight plans can be stored on or through the FMS or an external system or server, or both.

The aircraft can then be operated according to a particular flight plan (e.g., including a planned route, flight path, and airway). Each flight plan can include a respective set of flight parameters. For example, the flight parameters can include, without limitation, one or more of a flight path, a trajectory, (such as a 3-dimensional or 4-dimensional trajectory), an altitude, a flight level, an airspeed, a climb rate, a descent rate, a waypoint, a checkpoint, an airport, a turn radius, a fuel level, or any combination thereof. Typically, each respective flight plan will include a planned route plus any additional performance parameters (e.g. fuel) that are required to determine, calculate, estimate, or predict the flight parameters for that flight plan. The set of flight parameters for each respective flight plan can be calculated, predicted, estimated, or otherwise determined in advance of a flight, or updated, adjusted, modified, corrected, or otherwise changed while in flight, or both, based on the data (e.g., flight procedure data) in the NDB. Currently, however, the flight procedures or aviation data in the NDB are not automatically validated with respect to any particular flight plan, or set of flight plans, relative to predetermined flight criteria related to safe flight such as maintaining a predetermined minimum distance to terrain or other obstacles to avoid a risk of an undesired ground incursion during flight.

It will be appreciated that updates to the NDB may contain errors when generated or implemented, including data errors that could lead an aircraft in flight to fly to an undesired or unsafe location (e.g., too close to terrain) when a flight plan or flight parameter is determined based on the data in the NDB. Such errors in the data can have any number of sources, such as but not limited to human error (e.g., keying errors), software errors, programming errors, database errors, errors of nefarious intent (e.g., sabotage), or any combination thereof.

Regardless of the source of the error in the data, when an aircraft in flight enters or approaches an undesired or unsafe location (i.e., is at risk of an incursion), conventional systems such as EGPWS are configured to issue a warning or an alert to the pilot of the aircraft to initiate appropriate corrective actions (e.g. “Terrain—Pull Up!”). However, this conventional warning system has safety implications (e.g., reduction of safety margin), operational implications (e.g., flight diversion) and regulatory implications (e.g., mandatory reporting and associated investigation). Aspects as described herein can compare a set of flight plans determined based on aviation data from an NDB to terrain data from a terrain or obstacle database. For example, aspects as described herein can analyze the set of flight plans to identify or determine whether the data stored in the NDB can unintentionally increase a risk of an undesired ground incursion for an aircraft. In this way, aspects as described herein can identify data issues in advance, and allow for correction of the data, or flight plans based on the data, or both, and thereby avoid such undesired situations altogether.

Aspects of the present disclosure relate to a method and system for automatically performing a validation of a flight plan, prior to flight or an implementation of a flight plan. The validation of the flight plan can determine the flight plan will satisfy predetermined performance criteria (e.g., maintaining a predetermined minimum distance to terrain), or in the alternative, identify errors in the aviation data. In non-limiting aspects, the validation can be performed with a computer or an avionics device including an FMS, or the like. For ease of description and understanding, as used herein, the term “avionics device” can refer to interchangeably an on-board computer such as an FMS, or a computing device remote or removable from the aircraft. In other non-limiting aspects, the avionics device can include one or more computers, or the like, separate from the FMS.

Regardless of the source of the flight plan, prior to implementing the flight plan the computer can also receive obstacle data such as terrain data from a TAWS system, such as an EGPWS or another on-board source or external database. In aspects, the terrain data can be received from any desired source or database without limitation.

In non-limiting aspects, a set of aviation data from a first database (e.g., an NDB), can be received and stored in a second database (e.g., an on-board FMS or an external computer or database remote from an aircraft). Based on the set of aviation data, a set of flight procedures can be developed or defined. For example, the set of flight procedures can include arrival, departure, or approach procedures for one or more airports, aerodromes, heliports, runways, or the like. The set of flight procedures can be saved in the first or second database, or both. Based on the set of flight procedures, a set of flight plans can be determined or developed. The set of flight plans can be developed, calculated, predicted, estimated, planned, defined, or otherwise determined with respect to one or more aircraft types or models, one or more airports, or combinations thereof, and saved in the second database (i.e., the on-board FMS or the external database). For each flight plan of the set of flight plans, or a portion thereof, a respective set of flight parameters can then be calculated, predicted, estimated, or otherwise determined in advance of a corresponding flight. In non-limiting aspects, the respective set of flight parameters can be saved in the second database (i.e., the on-board FMS, external database, or a combination thereof). The computer or avionics device can also receive a set of obstacle data such as terrain data from a TAWS system, or another on-board source or other external database.

The computer or avionics device can be programmed or configured to perform a validation of one or more flight plans of the set of flight plans. In non-limiting aspects, the validation can include comparing the respective set of flight parameters of a particular flight plan with the set of obstacle data, and determining, based on the comparison, whether the flight plan presents satisfies one or more predetermined flight criteria related to safety. In non-limiting aspects, the predetermined criteria can be that the flight maintain at least a predetermined minimum distance to predetermined terrain features or other obstacles. For example, the comparison of the respective set of flight parameters with the set of obstacle data can indicate, for a particular flight plan, that a trajectory parameter for a particular flight path at a particular altitude would result in an undesired ground incursion the flight plan would thereby not satisfy the predetermined flight criteria. In other instances, the comparison of the respective set of flight parameters with the set of obstacle data can indicate or determine for a particular flight plan, that a trajectory parameter for a particular flight path at a particular altitude would result in the aircraft flying closer than a predetermined distance (e.g., a safe distance) to an obstacle to flight such as a terrain feature and would thereby not satisfy the predetermined flight criteria. In the event of a determination that a particular flight plan does not satisfy the predetermined flight criteria, the avionics device can then generate a notification indicative of the determination.

In some non-limiting aspects, the avionics device can provide an output indicative of a particular flight plan and one or more corresponding flight parameters to a display device. For example, the avionics device can provide a signal to the display device to cause the display device to display or identify (e.g., for the pilot or flight crew) information indicative of the set of flight parameters for the particular flight plan. In a non-limiting example, the information indicative of the set of flight parameters can include waypoints, flight paths, and altitudes. In still other aspects, the display may include a dynamic display to enable the pilot to iterate through a list such as a linked list or menu of the flight parameters.

In various non-limiting aspects, the avionics device can additionally or alternatively provide an output signal to the display device indicative of at least one of the terrain data and obstacle data. The terrain and obstacle data can be optionally be displayed adjacent or proximal to the display indicative of the set of flight parameters. In a non-limiting aspect, information indictive of topographical data can be displayed overlaying a display of a flight path to enable visual identifications of any obstacles that may be encountered based on the set of flight parameters. In one non-limiting example, the topographical data can be displayed as a map or chart, using an image of a complex polygon to indicate a terrain feature or other obstacle. Similarly, in an aspect, a flight parameter such as a trajectory can be displayed as line or curve, and can be further depicted in conjunction with or overlaying the displayed topographical data.

It is contemplated that based on the display, the pilot can review the set of flight parameters for the flight plan, or the terrain and obstacle data, or both. The pilot can choose to accept the set of flight parameters, or choose to enter a correction or change to one or more parameters of the set of flight parameters. For example, the pilot can enter a change to the flight plan or flight parameters or both via the FMS.

In the event that the validation determines the flight plan satisfies the predetermined flight criteria (for example, due to maintaining a predetermined minimum proximity to terrain), the avionics device can provide a signal (e.g., to the display device) indicative of the determination. The aircraft can then be operated according to the flight plan. In the event that the validation determines the flight plan would not satisfy the predetermined flight criteria, (e.g., due to not maintaining a predetermined minimum proximity to terrain), the avionics device can generate or trigger a warning signal indicative of the determination. For example, based on the validation, a warning signal may be provided to the display device to indicate the flight plan was not validated, because the flight plan did not satisfy the predetermined flight criteria due to a likelihood of an undesired ground incursion due by the aircraft when implementing the flight plan.

In some aspects, in the event that the flight plan is not validated, the avionics device can revise at least a portion of the flight plan to define a second flight plan having a second set of flight parameters. The second flight plan can likewise be authenticated and validated, via the avionics device. In the event that the validation determines the second flight plan satisfies the predetermined flight criteria, the second flight plan can be executed via the avionics device with minimal intervention required from a flight crew or pilot.

In some aspects, in the event that the safety of the flight plan is not validated, a record can be created for analysis. For example, the record can include without limitation any one or more of the flight plan, flight parameters, flight procedures, or aviation data associated with predetermined data fields associated with the predetermined flight criteria. It is contemplated that in such aspects, the record can be analyzed and errors in the aviation data can be identified based on the record and the analysis.

Aspects as disclosed herein can validate that a particular flight plan satisfies the predetermined flight criteria related to safety well in advance of warnings that would be triggered by a conventional TAWS or EGPWS, and if necessary, enable revising the particular flight plan to avoid the risks altogether. The flight plan can be validated and updated prior to executing the flight plan. For example, the set of flight parameters associated with the particular flight plan can be updated automatically through the avionics device, or manually, prior to executing the flight plan. It is contemplated that based on the predetermined flight procedures, a set of flight plans can be developed and validated well in advance of flight.

As used herein, all directional references (e.g., radial, axial, upper, lower, upward, downward, left, right, lateral, front, back, top, bottom, above, below, vertical, horizontal, clockwise, counterclockwise) are only used for identification purposes to aid the reader's understanding of the disclosure, and do not create limitations, particularly as to the position, orientation, or use thereof. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to each other. In non-limiting examples, connections or disconnections can be selectively configured to provide, enable, disable, or the like, an electrical connection or communicative connection between respective elements. Furthermore, as used herein, the term “set” or a “set” of elements can be any number of elements.

As used herein, the term “safe” or “safety” can refer to a condition, plan, parameter, action, or combination thereof that is unlikely to cause undesired danger, injury, loss, or damage. The danger, injury, loss, or damage can refer to such undesired outcomes to equipment or persons or both. As used herein, the term “validation” can refer to an action of validating, calculating, determining, assessing, estimating, confirming, proving, or the like that that a condition, plan, parameter, action, or combination thereof is likely to meet predetermined criteria.

As used herein, a “controller” or “controller module” can include a component configured or adapted to provide instruction, control, operation, or any form of communication for operable components to affect the operation thereof. A controller module can include any known processor, microcontroller, or logic device, including, but not limited to: Field Programmable Gate Arrays (FPGA), a Complex Programmable Logic Device (CPLD), an Application-Specific Integrated Circuit (ASIC), a Full Authority Digital Engine Control (FADEC), a Proportional Controller (P), a Proportional Integral Controller (PI), a Proportional Derivative Controller (PD), a Proportional Integral Derivative Controller (PID), a hardware-accelerated logic controller (e.g. for encoding, decoding, transcoding, etc.), the like, or a combination thereof. Non-limiting examples of a controller module can be configured or adapted to run, operate, or otherwise execute program code to effect operational or functional outcomes, including carrying out various methods, functionality, processing tasks, calculations, comparisons, sensing or measuring of values, or the like, to enable or achieve the technical operations or operations described herein. The operation or functional outcomes can be based on one or more inputs, stored data values, sensed or measured values, true or false indications, or the like. While “program code” is described, non-limiting examples of operable or executable instruction sets can include routines, programs, objects, components, data structures, algorithms, etc., that have the technical effect of performing particular tasks or implement particular abstract data types. In another non-limiting example, a controller module can also include a data storage component accessible by the processor, including memory, whether transition, volatile or non-transient, or non-volatile memory. Additional non-limiting examples of the memory can include Random Access Memory (RAM), Read-Only Memory (ROM), flash memory, or one or more different types of portable electronic memory, such as discs, DVDs, CD-ROMs, flash drives, Universal Serial Bus (USB) drives, the like, or any suitable combination of these types of memory. In one example, the program code can be stored within the memory in a machine-readable format accessible by the processor. Additionally, the memory can store various data, data types, sensed or measured data values, inputs, generated or processed data, or the like, accessible by the processor in providing instruction, control, or operation to affect a functional or operable outcome, as described herein.

The exemplary drawings are for purposes of illustration only and the dimensions, positions, order and relative sizes reflected in the drawings attached hereto can vary.

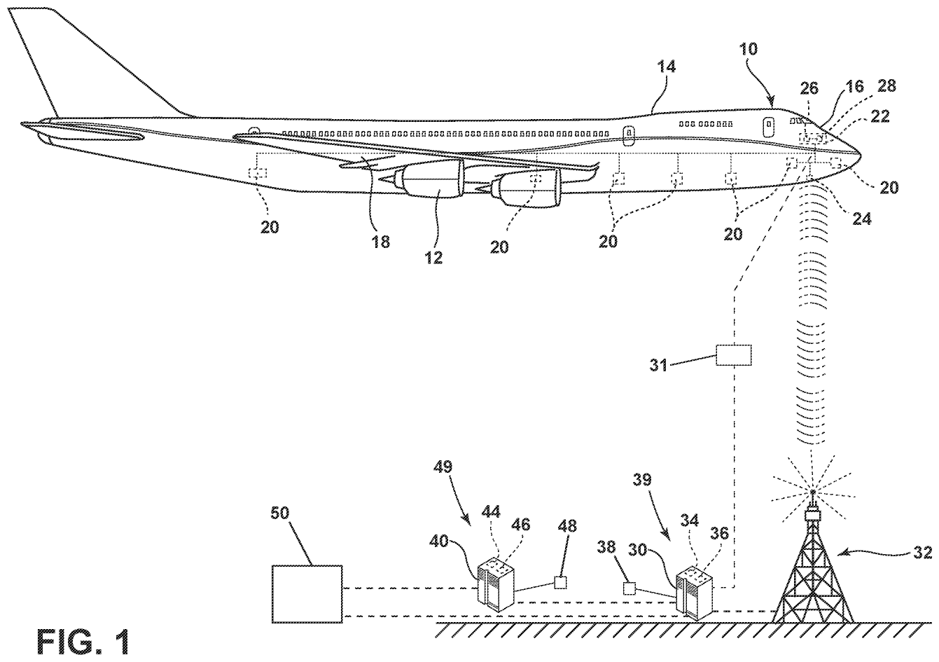

FIG. 1 depicts an aircraft 10 that provides an environment for different aspects of the disclosure. The aircraft 10 can fly a route from one location to another (i.e., a flight) and can include one or more propulsion engines 12 coupled to a fuselage 14. A cockpit 16 can be positioned in the fuselage 14 and wing assemblies 18 can extend outwardly from the fuselage 14. Further, a set of aircraft systems 20 that enable proper operation of the aircraft 10 can be included, as well as a controller or computer 22, and a communication system having a communication link 24. A first user interface is illustrated, by way of non-limiting example, as a first display device 29 that is communicatively coupled to or formed with the computer 22. The first display device 29 can be any user interface, screen, or known computer system or combination of computer systems that can communicate or otherwise provide an output to one or more users (e.g., a pilot) of the computer 22. For example, the first display device 29 can be located in the cockpit 16 of the aircraft 10. It is contemplated that the first display device 29 can also obtain or receive input from the one or more users of the computer 22. In non-limiting aspects, the computer 22 can include an FMS (not shown).

The set of aircraft systems 20 can reside within the cockpit 16, within the electronics and equipment bay (not shown), as well as in other locations throughout the aircraft 10 and can be associated with the engines 12. Such aircraft systems 20 can include but are not limited to an electrical system, an oxygen system, hydraulics or pneumatics system, a fuel system, a propulsion system, FMS, flight controls, audio/video systems, an Integrated Vehicle Health Management (IVHM) system, and systems associated with the mechanical structure of the aircraft 10.

The computer 22 can be operably coupled to the set of aircraft systems 20 and it is contemplated that the computer 22 can aid in operating the set of aircraft systems 20 and can receive information from the set of aircraft systems 20. The computer 22 can, among other things, automate the tasks of piloting and tracking the flight plan of the aircraft 10. The computer 22 can also be connected with other controllers or computers of the aircraft 10.

The computer 22 can include a memory 26. The memory 26 can include Random Access Memory (RAM), Read-Only Memory (ROM), flash memory, or one or more different types of portable electronic memory, such as discs, Digital Versatile disks (DVD), Compact Disc-Read-Only Memory (CD-ROMs), etc., or any suitable combination of these types of memory. The computer 22 can include one or more controller modules or processors, which can be running any suitable programs. It will be understood that the computer 22 can include or be associated with any suitable number of individual microprocessors, power supplies, storage devices, interface cards, auto flight systems, flight management computers, controller modules, and other standard components and that the computer 22 can include or cooperate with machine executable code, any number of software programs (e.g., flight management programs), or other instructions designed to carry out the various methods, process tasks, calculations, and control/display functions necessary for operation of the aircraft 10.

The computer 22 can include one or more processors, which can be running or executing any suitable programs. The computer 22 can include various components (not shown) as described herein. The computer 22 can include or be associated with any suitable number of individual microprocessors, power supplies, storage devices, interface cards, auto flight systems, flight management computers, and other standard components. The computer 22 can further include or cooperate with any number of software programs (e.g., flight management programs) or instructions designed to carry out the various methods, process tasks, calculations, and control/display functions necessary for operation of the aircraft 10.

While not illustrated, it will be understood that any number of sensors or other systems can also be communicatively or operably coupled to the computer 22 to provide information thereto or receive information therefrom. By way of non-limiting example, a navigation system including the GNSS receiver configured to provide data that is typical of GPS systems, such as the coordinates of the aircraft 10, can be coupled with the computer 22. Position estimates provided by the GNSS receiver can be replaced or augmented to enhance accuracy and stability by inputs from other sensors, such as inertial systems, camera and optical sensors, and Radio Frequency (RF) systems (none of which are shown for the sake of clarity). Such navigation data may be utilized by the FMS (not shown) or computer 22 for various functions, such as to navigate to a target position.

The communication link 24 can be communicably coupled to the computer 22 or other control modules or processors of the aircraft to transfer information to and from the aircraft 10. It is contemplated that the communication link 24 can be a wireless communication link and can be any variety of communication mechanism capable of wirelessly linking with other systems and devices and can include, but is not limited to, satellite uplink, SATCOM internet, very high frequency (VHF) Data Link (VDL), ACARS network, Automatic Dependent Surveillance-Broadcast (ADS-B), Wireless Fidelity (WIFI), WiMax, 3G wireless signal, Code Division Multiple Access (CDMA) wireless signal, Global System for Mobile communication (GSM), 4G wireless signal, Long Term Evolution (LTE) signal, 5G wireless signal or any combinations thereof. It will also be understood that the particular type or mode of wireless communication is not critical to the disclosure, and later-developed wireless networks are certainly contemplated as within the scope of the current disclosure. Further, the communication link 24 can be communicably coupled with the computer 22 through a wired link without changing the scope of this disclosure. Although only one communication link 24 has been illustrated, it is contemplated that the aircraft 10 can have multiple communication links communicably coupled with the computer 22. Such multiple communication links can provide the aircraft 10 with the ability to transfer information to or from the aircraft 10 in a variety of ways.

As illustrated, the computer 22 can communicate with a first remote server 30, which can be located anywhere. The communication between the first remote server 30 and the computer 22 can be via an external data storage device 31. Non-limiting examples of the external data storage device 31 can include, but is not limited to, hard drives, floppy disks, laptops, Universal Serial Bus (USB) drives, jump drives, mobile devices, CDs, storage arrays, or DVDs. Additionally, or alternatively, the computer 22 can communicate with a first remote server 30 located at or communicatively coupled to a designated ground station 32. Communication can be sent or received between the ground station 32 and the computer 22 via the communication link 24. The ground station 32 can be any type of communicating ground station 32 such as one operated by an Air Navigation Service Provider (ANSP)/Air Traffic Control (ATC).

A second remote server 40 can be in communication with the first remote server 30 or the ground station 32. The second remote server 40 can communicate with the first remote server 30 using any suitable wired or wireless communication link. While illustrated as the second remote server 40, any number of remote servers can be in communication with the first remote server 30.

The first and second remote servers 30, 40 can include a first computer searchable database 34 and a second computer searchable database 44, respectively. The first and second computer searchable databases 34, 44 can be accessible by a first controller module 36 and a second controller module 46. The first and second controller modules 36, 46 can independently run a set of executable instructions to access the first and second computer searchable databases 34, 44, respectively. The first and second remote servers 30, 40 can include a general-purpose computing device in the form of a computer, including a processing unit, a system memory, and a system bus, that communicatively couples various system components including the system memory to the processing unit. The system memory can include ROM and RAM. The computer can also include a magnetic hard disk drive for reading from and writing to a magnetic hard disk, a magnetic disk drive for reading from or writing to a removable magnetic disk, and an optical disk drive for reading from or writing to a removable optical disk such as a CD-ROM or other optical media. It will be understood that the first and second computer searchable databases 34, 44 can be any suitable database, including a single database having multiple sets of data, multiple discrete databases linked together, or even a simple table of data. It is contemplated that the computer searchable databases 34, 44 can include respective sets of separate databases.

A second user interface is illustrated, by way of non-limiting example, as a second display device 38 that is communicatively coupled to or formed with the first remote server 30. The second display device 38 can be any user interface, screen, or known computer system or combination or computer systems that can communicate or otherwise provide an output to one or more users of the first remote server 30. It is contemplated that the second display device 38 can also obtain or receive input from the one or more users of the first remote server 30.

A third user interface is illustrated, by way of non-limiting example, as a third display 48 that is communicatively coupled to or formed with the second remote server 40. The third display 48 can be any user interface, screen, or known computer system or combination or computer systems that can communicate or otherwise provide an output to one or more users of the second remote server 40. It is contemplated that the third display 48 can also obtain or receive input from the one or more users of the second remote server 40.

A first system 39 that can be adapted to interact with an NDB can be defined by the first remote server 30 or the first controller module 36. For example, the first system 39 can include a set of NDBs, for example a flight procedures database. The first controller module 36 can determine, calculate, or display a set of flight procedures or IFPs. The set of flight procedures can include a set of predetermined flight maneuvers to achieve safe flight operations and an orderly flow of air traffic. The set of flight procedures can be based in part on predefined minimum flight distances from obstacles. The set of flight procedures can include arrival, departure, or approach procedures for an airport or a set of airports. In aspects, the first controller module 36 can determine the set of flight procedures based on a set of aviation data 56 provided by the NDB. The first controller module 36 can determine, calculate, or display a flight plan or a set of flight plans based on the set of flight procedures stored in the first searchable database 34. The set of flight procedures, the set of flight plans, or both can be provided to the aircraft 10. For example, in non-limiting aspects, the set of flight procedures, the set of flight plans, or both can be provided from the first remote server 30 to the aircraft 10 via the ground station 32 and the communication link 24. The set of flight procedures and set of flight plans can be stored on the computer 22 or FMS (not shown). The flight procedures or flight plans can optionally be displayed on the first display device 29 or second display device 38.

In non-limiting aspects, a second system 49 can be defined by the second remote server 40 or the second controller module 46. In some aspects, the second system can be configured to one of compile, convert, store or a combination thereof Aeronautical Radio Incorporated (ARINC) 424 or Digital Aeronautical Flight Information File (DAFIF) files into a binary format.

It is contemplated that the first system 39 and the second system 49 can be housed on the same server. That is, the first and second remote servers 30, 40 can be a single server, where a single controller module can perform what is illustrated, by way of example, as being performed on the first and second controller modules 36, 46.

In non-limiting aspects, a data source 50 can be communicatively coupled with the first remote server 30, the second remote server 40, or both. The data source 50 can be programmed to provide the first remote server 30, the second remote server 40, or both, with incoming data that can be, for example, in the form of the ARINC 424 standard or the DAFIF. While illustrated as a single source, the data source 50 can be any number of sources. That is, the first remote server 30 and second remote server 40 can receive incoming data in a variety of forms and from any number of data sources 50. For example, the data source 50 can further include terrain and obstacle data, such as from a TAWS (not shown). The data source 50 can be configured to selectively provide the terrain and obstacle data to the first remote server 30 or second remote server 40. The data source 50 or sources can be communicatively coupled with the first remote server 30 or second remote server 40, or both, using any suitable wired or wireless communication link.

Flight plan information, such as the set of flight plans and other flight procedure information, can be supplied to the aircraft 10 via the communication link 24 from ground station 32 or any other suitable external source. Additionally, or alternatively, set of flight plans can be supplied to the computer 22 via an Electronic Flight Bag (EFB). The EFB (not shown) can be communicatively coupled to ground station 32 and the communication link 24 (for example, via an Aircraft Interface Device (AID), such that the flight plans, can be received by or contained within the EFB. The EFB can then subsequently upload the flight plan to the FMS via the communication link 24. The EFB can include a controller module, which can be configured to automatically perform the calculations, determinations, and executions, of the computer 22 or FMS. The controller module can be configured to run any suitable programs or executable instructions designed to carry out various methods, functionality, processing tasks, calculations, or the like, to enable or achieve the technical operations or operations described herein.

It will be appreciated that while FIG. 1 depicts an aircraft 10 as an environment for aspects for validating a flight plan 70 for the aircraft 10, other aspects are not so limited. Other non-limiting aspects need not be limited to any particular location (e.g., a location of computer 22) and aspects of the first system 39 can be located or arranged on the aircraft 10 or can be located or performed partially within, or entirely separate from the aircraft 10.

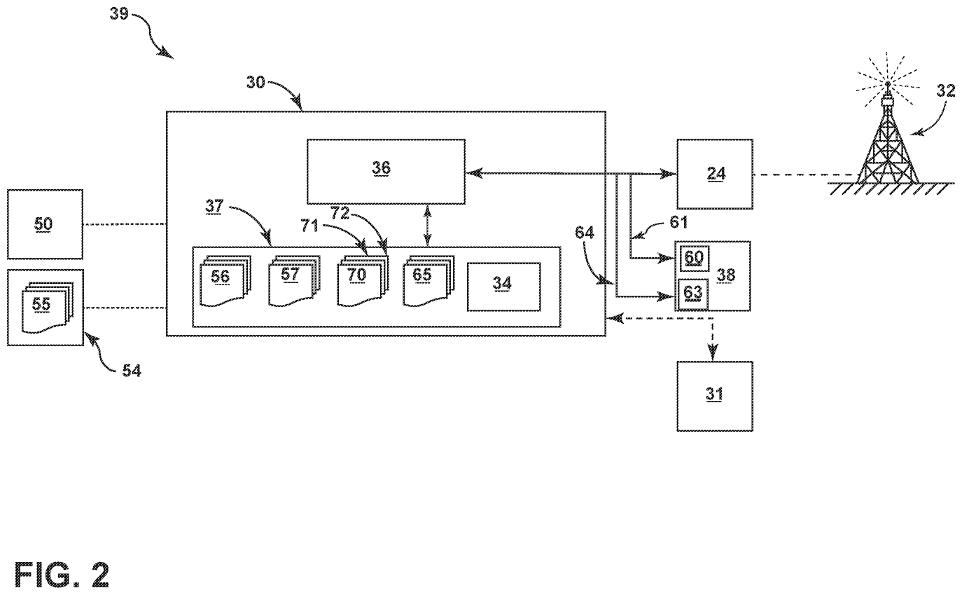

FIG. 2 illustrates a block diagram of a non-limiting aspect of the first system 39 including the first remote server 30, first controller module 36, and the first searchable database 34. The first controller module 36 can further include a memory 37. The memory 37 can be RAM, ROM, flash memory, or one or more different types of portable electronic memory, such as discs, DVDs, CD-ROMs, etc., or any suitable combination of these types of memory 37. The first remote server 30 can be communicatively coupled to at least one of a TAWS 54, the data source 50, the ground station 32, the external data storage device 31, and the second display device 38. The first remote server 30 can be communicatively coupled to the to the aircraft (not shown) via the ground station 32 and the communication link 24.

In non-limiting aspects, the first remote server 30 can be communicatively coupled to the data source 50 to receive a set of aviation data 56 such as Aeronautical Radio Incorporated (ARINC) 424 or Digital Aeronautical Flight Information File (DAFIF) files therefrom. In aspects, the first remote server 30 can additionally or alternatively receive a set of flight procedures 57 from the data source 50. In other aspects, the first remote server 30 can be configured to determine, calculate, or display the set of flight procedures 57 based on the set of aviation data 56. Additionally, in aspects, the first searchable database 34 can include or store data (such as the set of aviation data 56, or the set of flight procedures 57, or both, received from the second remote server 40. In non-limiting aspects, the first remote server 30 can be communicatively coupled to a TAWS 54 to receive terrain data 55 therefrom. In other aspects, the first searchable database 34 can selectively receive and store terrain data 55 received from at least one of the TAWS 54, the second remote server, and the data source 50. In non-limiting aspects, the TAWS 54 can be located on the aircraft (not shown).

The first controller module 36 can be communicatively coupled to the second display device 38 and arranged to provide information to be displayed in visual or auditory format, or both, to the second display device 38. Additionally, or alternatively, the first controller module 36 can be communicatively coupled to the first display device 29 via the communication link 24, the external data storage device 31, or both. The first controller module 36 can be optionally be arranged to provide information in visual or auditory format, or both, to the first display device 29 via the ground station 32.

In the illustrated non-limiting example, the first searchable database 34 can be included in the memory 37. It will be understood that the first searchable database 34 can be any suitable database, including a single first searchable database 34 having multiple sets of data, multiple discrete first searchable databases 34 linked together, or even a simple table of data. It is contemplated that the first searchable database 34 can incorporate a number of first searchable databases 34 or that the first searchable database 34 can actually be a set of first searchable databases 34. In a non-limiting aspect, the first searchable database 34 can be a conventional Navigation Database (NDB). The first searchable database 34 can contain information including, but not limited to, airports, runways, airways, waypoints, navigational aids, airline/company-specific routes, and procedures such as approaches, Standard Instrument Departure (SID), and Standard Terminal Approach Routes (STAR). In some aspects, the first searchable database 34 can additionally or alternatively contain or store terrain data 55 or obstacle data alone or in combination. In various non-limiting aspects, the first remote server 30 can receive at least one of the terrain data 55, and aviation data 56 from the first searchable database 34, memory 37, TAWS 54, ground station 32, data source 50, or any combination thereof.

The first controller module 36 can be configured to define, develop, calculate or otherwise determine a set of flight plans 70. Each flight plan 70 of the set of flight plans 70 can include a respective set of flight parameters 71. Each flight plan 70 can include or be associated with predetermined flight criteria 72. In non-limiting aspects the predetermined flight criteria 72 can include maintaining a predetermined minimum distance to terrain or other obstacles to avoid a risk of an undesired ground incursion during flight. In aspects, the first controller module 36 can determine the set of flight plans 70 based on the set of aviation data 56. The set of flight plans 70, can be further based on a predetermined model or type of aircraft. For example, each respective flight plan 70 can include a respective departure location, a planned route, a destination, and any additional performance parameters (e.g. fuel) that are required to determine, calculate, estimate, or predict the respective flight parameters 71 for the respective flight plan 70. The flight parameters 71 can include, without limitation, one or more of a flight path, a 3-dimensional trajectory, a 4-dimensional trajectory, an altitude, a flight level, an airspeed, a climb rate, a descent rate, a waypoint, a checkpoint, an airport, a turn radius, a fuel level, or any combination thereof.

The first controller module 36 can be further configured to perform the validation that the set of flight plans 70 or a portion thereof satisfy the predetermined flight criteria 72. The validation can include comparing, for each flight plan 70, the respective set of flight parameters 71 with the terrain data 55. The first controller module 36 can then determine, based on the comparison, whether a particular flight plan 70 satisfies the predetermined flight criteria 72. For example, the respective set of flight parameters 71 for a particular flight plan 70 can be compared with the terrain data 55. The comparison by the first controller module 36 of the flight parameters 71 to the terrain data 55, can determine or indicate, for example, that one or more flight parameters 71 could result in an undesired ground incursion by the aircraft (not shown), and would thereby not satisfy the predetermined flight criteria 72. In non-limiting aspects, the comparison of the respective set of flight parameters 71 with the terrain data 55 for a particular flight plan 70 can be based on a predetermined proximity tolerance (for example, a predetermined distance to an obstacle, such as a terrain feature). In such aspects, the comparison by the first controller module 36 of the respective set of flight parameters 71 to the terrain data 55, can indicate, for example, that one or more flight parameters 71 could result in the aircraft flying closer than a predetermined distance to an obstacle, and would thereby not satisfy the predetermined flight criteria 72.

The first controller module 36 can be further configured to generate a first notification 60 in the event of a determination that a particular flight plan 70 does not satisfy the predetermined flight criteria 72. For example, the controller module can provide a first signal 61 to the second display device 38 to trigger the first notification 60 to be displayed on the second display device 38. In aspects, the notification can include an alarm or alert indicative of any flight criteria that would not be satisfied. In non-limiting aspects, the first notification 60 can include information indicative of at least of one or more particular flight parameters 71 and the terrain data 55 associated with predetermined flight criteria 72. In aspects, the first notification 60 can include a visual display (not shown) on the first display device 29 or the second display device 38 or both. In aspects, the visual display can include a linked list or menu of each flight parameter 71 associated with the predetermined flight criteria 72.

In non-limiting aspects, based on the determination that the flight plan would not satisfy the predetermined flight criteria 72, first controller module 36 can be further configured to additionally or alternatively create a record 65 such as a summary, log entry, or the like. In an aspect, the first controller module 36 can save the record 65 to memory 37 (e.g., to a log file), and can include predetermined details associated with the determination that operating the aircraft 10 in accordance with the set of flight plans 70 would not satisfy predetermined flight criteria 72. The record 65 can include, for example, a set of predetermined details or data fields associated with the flight plan 70, the respective set of flight procedures 57, the aviation data 56, the respective a set of flight parameters 71, or the terrain data 55, or combinations thereof. The first controller module 36 can be further configured to display the record 65 on the first display device 29, second display device 38 or both. The first controller module 36 can additionally, or alternatively, save the record 65 to a memory on the aircraft, such as the FMS. It is contemplated that the created record 65 can be selectively retrieved from memory to be used by the by a pilot or other authorized user, for example by air-traffic control personnel or aviation authorities, for subsequent analysis of at least one of the set of aviation data 56, set of flight procedures 57, terrain data 55, and flight plans 70. For example, in non-limiting aspects, it is further contemplated that the pilot or other authorized user can provide, send, or otherwise convey the record 65 or a copy thereof to aviation authorities, for example, a government authority or regulator (e.g., the FAA, a local municipal authority, or the like) for analysis and review of the aviation data to identify any errors therein.

It is contemplated that in some aspects, the pilot or other authorized user can review the visual display or record 65, or both, and selectively modify specific flight parameters 71 to satisfy the predetermined flight criteria 72. For example, in some aspects, the first notification 60 can include a visual display indicative of terrain data overlaying a visual display indicative of a flight path associated with a respective flight plan 70. It is contemplated that based on the visual display, the pilot or authorized user can review the set of flight parameters 71 or other displayed information. The pilot can choose to accept the flight plan 70, or choose to manually modify or enter a change to one or more flight parameters 71 to satisfy the predetermined flight criteria 72. For example, the pilot can selectively adjust or modify, without limitation, a flight path, a trajectory, an altitude, a flight level, a climb rate, a descent rate, a waypoint, a checkpoint, or a combination thereof, to maintain a predetermined distance to a terrain feature during flight in order to satisfy predetermined flight criteria 72 for the flight plan. In non-limiting aspects, the pilot or other authorized personnel can then choose to repeat the validation of the flight plan, based on the modified set of flight parameters 71, to determine whether the modified flight parameters 71 will enable the flight plan 70 to satisfy the predetermined flight criteria 72.

In non-limiting aspects, the first controller module 36 can be further configured to generate a second notification 63 in the event of a determination that a particular flight plan 70 satisfies the predetermined flight criteria 72. For example, the first controller module 36 can provide a second signal 64 to the second display device 38 to trigger the second notification 63 to be displayed on the second display device 38. In aspects, the second notification 63 can include a message indicative of the determination that the flight plan 70 satisfies the predetermined flight criteria 72.

It will be appreciated that non-limiting aspects of the first system 39 for validating a flight plan 70 depicted in FIG. 2, are not limited to any particular location (e.g., a location of the first controller module 36) and aspects of the first system 39 can be located or arranged on the aircraft 10, or can be located partially within, or entirely remote from the aircraft 10.

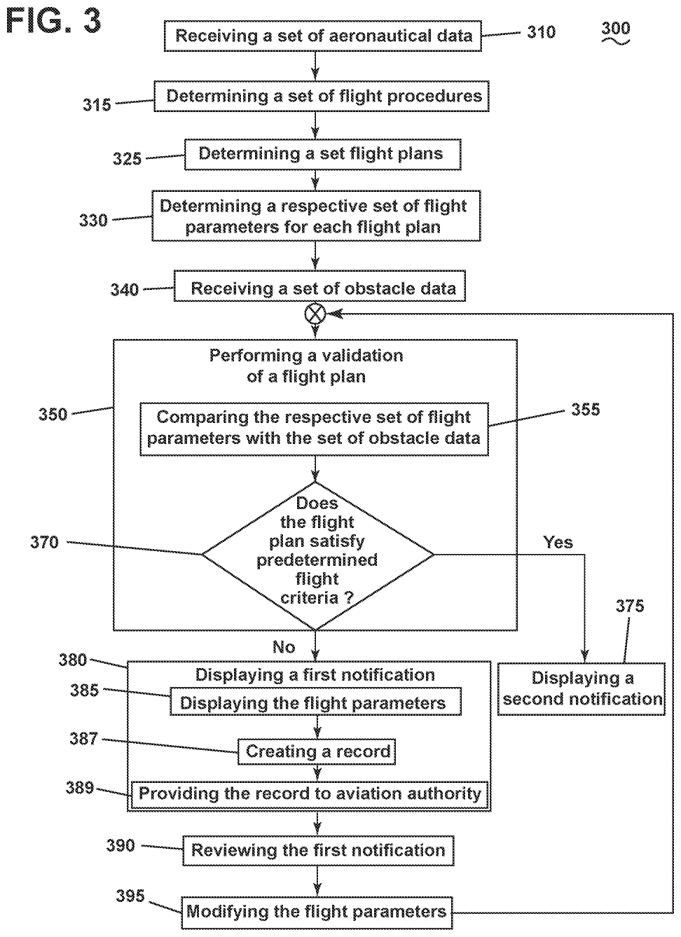

FIG. 3 illustrates a non-limiting example of a method 300 of validating aviation data. The method 300 can begin by receiving a set of aviation data from a data source 50 at 310. In various aspects, the set of aviation data 56 can be received by a computing device located on-board an aircraft 10, or remote from the aircraft 10. For example, the set of aviation data 56 can be manually entered into the remote server 30 to be stored in a memory 37, or uploaded or otherwise provided by an external source 50. In aspects, the aviation data 56 can include a set of flight procedures 57. The set of flight procedures 57 can include a set of predetermined maneuvers to achieve orderly flight operations. The set of flight procedures 57 can be based in part on predefined minimum flight distances from obstacles. The set of flight procedures 57 can include arrival, departure, or approach procedures for an airport or a set of airports. In other aspects, the method 300 can include at 315 determining the set of flight procedures 57 based on the set of aviation data 56 provided by the data source 50.

The method 300 includes determining a set of flight plans 70 based on the aviation data at 325. In non-limiting aspects, the determining a set of flight plans 70 can be done by an onboard computer 22 such as an FMS. In other non-limiting aspects, the determining a set of flight plans 70 can be done by a computing device separate from the aircraft, such as the remote server 30.

The set of flight plans 70 can include at least a respective planned route or flight path for a respective flight of an aircraft. The set of flight plans 70 can be developed, calculated, predicted, estimated, planned, defined, or otherwise determined with respect to one or more aircraft types or models, one or more airports, or combinations thereof. The set of flight plans 70 can include predetermined flight criteria 72. In non-limiting aspects, the predetermined flight criteria 72 can include maintaining a predetermined minimum distance to terrain or other obstacles to avoid a risk of an undesired ground incursion during flight. The set of flight plans 70 can be saved to a database such as an on-board data base or an external database. In aspects, the determining the set of flight plans 70 can include determining a respective set of flight parameters 71 for each flight plan 70 at 330. The set of flight parameters 71 can include any one or more of, but is not limited to, a respective one or more of a flight path, a trajectory, a 3DT, a 4DT, an airway, an altitude, a flight level, an airspeed, a climb rate, a descent rate, a waypoint, a checkpoint, an airport, a turn radius, or any combination thereof.

The method 300 can include, at 340 receiving a set of terrain data 55 and, at 350, performing a validation of the set of flight plans 70. In non-limiting aspects, the performing a validation of the set of flight plan can be done by an onboard computer 22 or avionics device, such as an FMS. In other non-limiting aspects, the performing a validation of the set of flight plans can be done by a computing device, such as the remote server 30 separate from the onboard computer 22 or avionics device. In such aspects, for example, in the event the set of flight plans 70 is determined by the onboard computer 22 or avionics device, the validation of the set of flight plans 70 by the computing device separate from the onboard computer 22 or avionics device can be indicative of the health, integrity and performance of the computer 22 or avionics device. In aspects, the validation can include comparing the respective set of flight parameters 71 with the set of terrain data 55 at 355.

The method 300 continues at 370 by determining, based on the comparison, whether each flight plan 70 satisfies the predetermined flight criteria 72. In the event of a determination that a particular flight plan 70 does not satisfy the predetermined flight criteria 72, the method can include displaying a first notification 60 indicative of the determination at 380. In aspects, the first notification 60 can include an alert or alarm, such as a visual or audible alert, indicative of the determination that the particular flight plan 70 does not satisfy the predetermined flight criteria 72. In some aspects, the first notification 60 can include a display of terrain data overlaying a display of a flight path associated with the flight plan 70. In aspects, the first notification 60 can be displayed on a first display device 29 such as any user interface, screen, or known computer system or combination of computer systems that can communicate or otherwise provide an output to one or more users (e.g., a pilot) of the aircraft 10. For example, the first display device 29 can be located in the cockpit 16 of the aircraft 10. It is contemplated that the first display device 29 can also obtain or receive input from the pilot or other users of the first display device 29. Additionally, or alternatively, the first notification 60 can be displayed on a second display device 38. The second display device 38 can be any user interface, screen, or known computer system or combination or computer systems that can communicate or otherwise provide an output to one or more users. For example, the second display device 38 can be located remote from the aircraft 10. It is contemplated that the second display device 38 can also obtain or receive input from the one or more users.

In aspects, the displaying a first notification 60 indicative of the determination can include displaying a list or menu of each flight parameter associated with the determination that the flight plan 70 does not satisfy predetermined flight criteria 72, such as shown at 385. For example, the displayed list can include predetermined information corresponding to the flight plan 70, the respective set of flight procedures 57, the aviation data 56, the respective set of flight parameters 71, or the terrain data 55, or combinations thereof.

In non-limiting aspects, the displaying the first notification 60 can additionally or alternatively include creating a record 65, such as a summary, log entry, or the like, at 387. In an aspect, the record 65 can be saved to memory 37 (e.g., to a log file), and can include predetermined details associated with the determination that operating the aircraft 10 in accordance with the set of flight plans 70 would not satisfy predetermined flight criteria 72 for the flight plan 70. The record 65 can include, for example, a set of predetermined details or data fields associated with the flight plan 70, the respective set of flight procedures 57, the aviation data 56, the respective a set of flight parameters 71, or the terrain data 55, or combinations thereof. The record 65 can be displayed on the first display device 29, second display device 38 or both. The record 65 can additionally, or alternatively, be saved to a memory on the aircraft, such as the FMS, or a memory 37 remote from the aircraft 10, or both. It is contemplated that the created record 65 or summary can be selectively retrieved from memory 37 to be used by the by a pilot or other authorized user, for example by air-traffic control personnel or aviation authorities, for subsequent analysis of at least one of the set of aviation data 56, set of flight procedures 57, and flight plans 70. It is further contemplated that the method 300 can include providing the record 65, or a copy thereof to aviation authorities, for example, a government authority or regulator (e.g., the FAA, a local municipal authority, or the like) at 389.

The method 300 can include reviewing the first notification 60, such as at 390. In non-limiting aspects, the reviewing of the first notification 60 can be done by a pilot or other authorized user, for example by air-traffic control personnel. The reviewing of the first notification 60 can include a visual review of the first notification 60 appearing on one of the first display device 29 and second display 38, or review of the record 65, or a combination thereof. It is contemplated that the reviewing of the first notification 60 can be done automatically, for example by the FMS. Based on the review of the first notification 60, the method 300 can further include modifying the set of flight parameters 71 such that the flight plan 70 will satisfy the predetermined flight criteria 72, such as at 395. For example, in response to reviewing the first notification 60, the pilot or other authorized personnel can modify one or more flight parameters 71 associated with the determination that the particular flight plan 70 does not satisfy the predetermined flight criteria 72. For example, the pilot can selectively adjust or modify, without limitation, a flight path, a trajectory, an altitude, a flight level, a climb rate, a descent rate, a waypoint, a checkpoint, or a combination thereof, to maintain a predetermined distance to a terrain feature during flight, in order to satisfy predetermined flight criteria 72 for the flight plan 70. In non-limiting aspects, the pilot or other authorized personnel can then choose to repeat the validation of the flight plan at 350, based on the modified set of flight parameters 71, to determine whether the modified flight parameters 71 will enable the flight plan 70 to satisfy the predetermined flight criteria 72 at 370. In other aspects, in response to modifying the set of flight parameters at 395, the method 300 can include automatically repeating the validation of the flight plan at 350, based on the modified set of flight parameters 71, to then determine whether the modified flight parameters 71 will enable the flight plan 70 to satisfy the predetermined flight criteria 72 at 370.

In non-limiting aspects, in the event of a determination that a particular flight plan 70 satisfies the predetermined flight criteria 72, the method can include, at 375, displaying a second notification 63. For example, the displaying a second notification 63 can include displaying a message indicative of the determination that the flight plan 70 satisfies predetermined flight criteria 72. In aspects, the second notification 63 can be displayed on the first display device 29 or the second display device 38, or both. The second notification 63 can additionally, or alternatively, be saved to a memory on the aircraft, such as the FMS, or a memory 37 remote from the aircraft 10, or both.

The method 300 can be performed pre-flight (i.e., prior to executing a particular flight plan 70) or triggered by an event, or as otherwise determined necessary (e.g., by a pilot or aviation authority). It is contemplated that the execution of method 300 is not limited to a specific computer or controller, and in various aspects, can be done using any desired computer or controller without departing from the scope of the disclosure. It will be appreciated that non-limiting aspects of the method 300, are not limited to performance at any particular location (e.g., a location of the first controller module 36) and aspects of the method 300 can be executed on the aircraft 10, or can be executed remote from the aircraft 10, or a combination thereof.

The sequences depicted are for illustrative purposes only and is not meant to limit the methods 300 in any way as it is understood that the portions of the method can proceed in a different logical order, additional or intervening portions can be included, or described portions of the method can be divided into multiple portions, or described portions of the methods can be omitted without detracting from the described method. For example, the methods 300 can include various other intervening steps. The examples provided herein are meant to be non-limiting.

It is contemplated that aspects of this disclosure can be advantageous for use over conventional systems or methods to validate a set of flight plans satisfy predetermined flight criteria. Aspects of this disclosure reduce workload of pilot and other personnel checking a flight plan or set of flight plans.

It is further contemplated that aspects of this disclosure can advantageously reduce errors associated with predetermined flight plans, thereby reducing the number of flight diversions, and the number of warnings due to erroneous flight plans. Mandatory reporting and investigations can likewise be advantageously reduced.

Additionally, safety issues can be identified well in advance of warnings that would be provided by a TAWS or EGPWS. This not only enhances safety but further provides additional time to determine alternative flight parameters to avoid the safety issue altogether. The method disclosed herein, however, does not require intensive manual interactions from the flight crew or the pilot, nor reliance on an EGPWS. In fact, the methods described herein can in some instances not require any interaction from the flight crew or the pilot.

To the extent not already described, the different features and structures of the various embodiments can be used in combination with each other as desired. That one feature is not illustrated in all of the embodiments is not meant to be construed that it may not be included, but is done for brevity of description. Thus, the various features of the different embodiments may be mixed and matched as desired to form new embodiments, whether or not the new embodiments are expressly described. All combinations or permutations of features described herein are covered by this disclosure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Various characteristics, aspects and advantages of the present disclosure may also be embodied in any permutation of aspects of the disclosure, including but not limited to the following technical solutions as defined in the enumerated aspects:

A method for validating a flight plan for an aircraft, the method comprising: receiving aviation data from a first database; determining a flight plan based on the aviation data; determining a set of flight parameters for the flight plan; receiving terrain data from a second database; and performing a validation of the flight plan, wherein the validation comprises: comparing the set of flight parameters with the terrain data; and determining, based on the comparison, whether the flight plan satisfies a predetermined flight criteria; and in the event of a determination that the flight plan does not satisfy the predetermined flight criteria related to safety; and displaying a first notification indicative of the determination when the determining indicates that the flight plan does not satisfy the predetermined flight criteria.

The method of the preceding clause, further including determining a set of flight procedures based on the aviation data prior to determining the flight plan.

The method of any preceding clause, wherein the predetermined flight criteria is a minimum distance to one of a terrain feature and an obstacle during flight.

The method of any preceding clause, wherein the first notification includes a display of flight parameters associated with the determination that the flight plan does not satisfy the predetermined flight criteria.

The method of any preceding clause, further comprising, when it is determined the flight plan satisfies the predetermined flight criteria, generating a second notification indicative of the determination.

The method of any preceding clause, wherein the determining a flight plan based on the aviation data is done by an avionics device.

The method of any preceding clause, wherein the performing a validation of the flight plan is done by a computing device separate from the avionics device.

The method of any preceding clause, further comprising modifying the set of flight parameters such that the flight plan will satisfy the predetermined flight criteria.

The method of any preceding clause wherein the validation is performed by an avionics device on an aircraft.

The method of any preceding clause, wherein the terrain data is received from a Terrain Avoidance Warning System on an aircraft.

The method of any preceding clause, further comprising, when the flight plan does not satisfy the predetermined flight criteria, creating a record comprising aviation data received from the first database associated with predetermined data fields associated predetermined flight criteria.

The method of any preceding clause, further comprising providing the record to an aviation authority.

A system for an aircraft, comprising: a controller module configured to: receive aviation data from a first database; determine a flight plan based on the aviation data; determine a set of flight parameters for the flight plan; receive terrain data from a second database; and perform a validation of the flight plan, wherein the validation comprises: comparing the set of flight parameters with the terrain data; and determining, based on the comparison, whether the flight plan satisfies predetermined flight criteria, and in the event of a determination that the flight plan does not satisfy the predetermined flight criteria, displaying a first notification indicative of the determination on a display.

The system of any preceding clause, wherein the controller module is further configured to determine a set of flight procedures based on the aviation data, prior to determining the flight plan.

The system of any preceding clause, wherein the controller module is further configured to display, in the event it is determined that the flight plan does not satisfy predetermined flight criteria, a first notification indicative of the determination.

The system of any preceding clause, wherein the controller module is onboard an aircraft.

The system of any preceding clause, further including displaying a list of one or more flight parameters associated with the determination that the flight plan does not satisfy predetermined flight criteria.

The system of any preceding clause, wherein the controller module is further configured to display, in the event it is determined that the flight plan does not satisfy predetermined flight criteria, a second notification indicative of the determination.

The system of any preceding clause, wherein the controller module is further configured to create a record comprising aviation data received from the first database associated with predetermined data fields, in the event it is determined that the flight plan does not satisfy the predetermined flight criteria.

The system of any preceding clause, wherein the terrain data is received from a Terrain Avoidance Warning System on an aircraft.

What is claimed is:

1. A method to validate a flight plan for an aircraft, the method comprising:
receiving aviation data from a first database;
determining a flight plan based on the aviation data;
determining a set of flight parameters for the flight plan;
receiving terrain data from a second database; and
performing a validation of the flight plan, wherein the validation comprises:
comparing the set of flight parameters with the terrain data; and
determining, based on the comparing, whether the flight plan satisfies predetermined flight criteria related to safety; and
when the determining indicates that the flight plan does not satisfy the predetermined flight criteria, displaying a first notification.

2. The method of claim 1, further including determining a set of flight procedures based on the aviation data prior to determining the flight plan.

3. The method of claim 1, wherein the predetermined flight criteria comprises a minimum distance to one of a terrain feature and an obstacle during a flight of the aircraft.

4. The method of claim 1, wherein the first notification includes a display of flight parameters associated with the determination that the flight plan does not satisfy the predetermined flight criteria.

5. The method of claim 1, further comprising, when it is determined the flight plan satisfies the predetermined flight criteria, generating a second notification.

6. The method of claim 1, wherein the determining a flight plan based on the aviation data is done by an avionics device.

7. The method of claim 6, wherein the performing a validation of the flight plan is done by a computing device separate from the avionics device.

8. The method of claim 7, further comprising modifying the set of flight parameters such that the flight plan will satisfy the predetermined flight criteria.

9. The method of claim 1, wherein the validation is performed by an avionics device onboard the aircraft.

10. The method of claim 1, wherein the terrain data is received from a Terrain Avoidance Warning System onboard the aircraft.

11. The method of claim 1, further comprising, when the flight plan does not satisfy the predetermined flight criteria, creating a record comprising aviation data received from the first database associated with predetermined data fields associated predetermined flight criteria.

12. The method of claim 11, further comprising providing the record to an aviation authority.

13. A system to validate a flight plan for an aircraft, comprising:
a controller module configured to receive aviation data from a first database, determine a flight plan based on the aviation data, determine a set of flight parameters for the flight plan, receive terrain data from a second database, and perform a validation of the flight plan, wherein the validation comprises:
comparing the set of flight parameters with the terrain data;
determining, based on the comparing, whether the flight plan satisfies predetermined flight criteria; and when the determining indicates that the flight plan does not satisfy the predetermined flight criteria; and
displaying a first notification indicative of the determination on a display.

14. The system of claim 13, wherein the controller module is further configured to determine a set of flight procedures based on the aviation data, prior to determining the flight plan.

15. The system of claim 13, wherein the validation further comprises modifying the set of flight parameters based on the first notification.

16. The system of claim 13, wherein the controller module is onboard the aircraft.

17. The system of claim 13, wherein the first notification comprises a list of one or more flight parameters associated with the determination that the flight plan does not satisfy predetermined flight criteria.

18. The system of claim 13, wherein the controller module is further configured to display, when it is determined that the flight plan satisfies the predetermined flight criteria, a second notification indicative of the determination.

19. The system of claim 13, wherein the controller module is further configured to create a record comprising aviation data received from the first database associated with predetermined data fields, based on the determining that the flight plan does not satisfy the predetermined flight criteria.

20. The system of claim 13, wherein the terrain data is received from a Terrain Avoidance Warning System on the aircraft.
